(19) United States
(12) Patent Application Publication
(10) Pub. No.: US 2009/0206517 A1
(43) Pub. Date: Aug. 20, 2009

(54) CENTRIFUGAL CASTING METHOD FOR FORMING A FRAME AND DEFINING MOULD THEREFOR

(75) Inventors: Erhard Rudolf, Oberndorf (DE); Markus Glueck, Nordlingen (DE); Franz Fastner, Rain-Etting (DE)

Correspondence Address: Kaplan Gilman & Pergament LLP, 1480 Route 9 North, Woodbridge, NJ, 07095, US

(73) Assignee: IP AG, Feldmeilen (CH)

(21) Appl. No.: 11/719,380

(22) PCT Filed: Nov. 14, 2005
(86) PCT No.: PCT/EP2005/055943

§ 371 Date: May 1, 2009

(30) Foreign Application Priority Data
Nov. 15, 2004 (EP) 04027143.9

(51) Int. Cl. B29C 41/30

(52) U.S. Cl. 264/261; 425/402

(57) ABSTRACT

The invention relates to a method for forming an edge enclosure. A defining mould (100) is provided, in which at least one disc-shaped element (2, 3, 4, 5, 6) is arranged and which surrounds the element at least at the edge. The at least one element is set in rotation (40), whereby casting compound introduced into the defining mould localises in the edge region (7) of the at least one element and cures there, so as to produce an edge enclosure (10) which at least partially surrounds the at least one element in a form-fitting manner.

### FIELD OF INVENTION

The present invention relates to a method with which at least one disc-shaped element, for example a filter means, can be bordered and enclosed in a form-fitting manner. Furthermore, it relates to a defining mould for use in the method.

### BACKGROUND

In the art, it is often necessary to enclose a flat, disc-shaped element with a form-fitting border or to join together a plurality of flat, disc-shaped elements. One possibility for such a connection is the edge bond by means of an edge enclosure. This bond is essential in the case of certain disc-shaped elements, e.g. filter means. A filter means is an element which is used in a filtration device and which effects the actual filtration process, e.g. the separation of specific substances. Frequently, a plurality of filter means are used in a single filtration device. Filter means are usually of multilayer construction, a courser drainage fabric generally being arranged in the middle and surrounded by at least one layer of a finer filter membrane in each case. The mechanical stress of the welding in the edge region thus leads to the production of kinks in the fine membrane material, which subsequently, in particular during backwashing steps, may lead to the destruction of the filter means. Injection moulding methods are not usable, for example, in the case of fine-pored membrane filters, metal or polymer membranes, since the capillary action here leads to the penetration of the plastic material or joining material into the membrane and thereby the obstruction of the membranes, so that a considerable part of the filter area is lost or the filter fabric is completely obstructed.

Such problems arise in the case of the edge connection of a plurality of layers of a porous or net-like fabric to form a sandwich-like disc-shaped element of another kind, not only in the production of filter means. An example which may be mentioned here is the production of fuel cells, or more precisely the proton-exchange membrane fuel cell (PEMFC) and the direct-methanol fuel cell (DMFC), in each of which the membrane as electrolyte and the two electrodes have to be joined together. Huge leak-tightness problems are constantly arising in this regard.

### SUMMARY OF THE INVENTION

The object of the present invention is therefore to provide a method with which a form-fitting edge enclosure can be formed around at least one flat disc-shaped element. In particular, at least two disc-shaped elements are to be connectable to one another to form a disc-shaped element, which connection is to be effected in a material-preserving and durable manner. Furthermore, the joining of a wide variety of materials is to be possible with the method and at the same time the individual elements are to be joined in a sealing manner.

This object is achieved by a method according to claim 1 and a defining mould according to claim 11. Preferred exemplary embodiments are dealt with in the subclaims.

According to the invention, a method is provided with which a form-fitting edge enclosure is formed around at least one flat, disc-shaped element. According to a preferred exemplary embodiment, at least two disc-shaped elements are joined at the edge in a form-fitting manner by the edge enclosure. For this, a defining mould is provided in which the at least one element is arranged. The flat, disc-shaped element may be both laid in and stood in the defining mould. The defining mould surrounds the element at least at the edge. According to a preferred exemplary embodiment, there is a certain distance between the defining mould and the edge of the element. The at least one element is then set in rotation, whereby casting compound, which is or has been introduced into the defining mould, accumulates in the edge region of the element and cures there. In this way, the edge enclosure is produced. Depending on the arrangement of the disc-shaped element, a form-fitting edge enclosure can thus be produced in a single operation (in the case of circular elements which are laid in) or in a plurality of operations.

With the method according to the invention, an edge enclosure forming a seal on all sides is formed around at least one flat, disc-shaped element. The product produced with the method is, in turn, flat and disc-shaped. The term “flat” in connection with the elements to be provided with an edge enclosure means that the elements have a very much smaller height than diameter. An example is given below. The term “disc-shaped”, in turn, means that the element thus described has a smaller height than its diameter, e.g. a cylinder whose height is less than its diameter. At the same time, the disc-shaped element may be of any shape, but preferably circular elements are to be provided with an edge enclosure in the method according to the invention. A disc-shaped element is thus always a flat element as well.

Preferably, the defining mould according to the invention is an open mould. The defining mould is then open towards the axis of rotation. For this reason alone, this method differs essentially from the injection moulding method, which requires a closed and leak-tight mould. Furthermore, the plastic has to be introduced under pressure in the injection moulding method, which is not necessary in the present rotational moulding method.

The method according to the invention is, consequently, a rotational moulding method. The element to be enclosed is set in rotation. The rotation may in this case be both horizontal and vertical. As a result, centrifugal forces act upon on the casting compound introduced, so that the casting compound concentrates in the edge region of the disc-shaped element. The centrifugal forces which occur here counteract in particular the capillary action, which would otherwise lead to casting compound being sucked into the element, for example the membrane, and migrating in the direction of the centre of the disc-shaped element. The casting compound is, consequently, only deposited in the edge region of the element. The inner edge of the edge enclosure is definable in the method according to the invention. A filter membrane, for example, will thus not be obstructed, but rather an edge enclosure of defined thickness and hence inner edge will be formed around it. The edge enclosure is in this case built up from the outside inwards. Casting compound is firstly deposited in the outermost region and then advances further and further in the direction of the centre of the element. It is thereby possible to produce a very limited form-fitting edge enclosure in the form of a closed ring.

The thickness of the edge enclosure is easily adjustable by the amount of casting compound supplied and the rotational speed. For example, in tests by the inventors, a rotational speed of 500-4000 rpm has proved to be suitable for disc-shaped elements with a diameter of 312 mm and a thickness of 4 mm. For a person skilled in the art, it is a straightforward matter to find out an amount of casting compound and a rotational speed which are suited to the diameter and the overall thickness of the disc-shaped element and the corresponding casting mould.

The method according to the invention has manifold advantages.

For instance, any sizes of disc-shaped elements can be provided with a form-fitting edge enclosure. A person skilled in the art needs merely to produce a corresponding defining mould and to ascertain the amount of casting compound and the corresponding rotational speed. Moreover, it is also possible for form-fitting and sealing edge enclosures to be formed around profiled elements, e.g. profiled filter means.

Unlike injection moulding methods, for which the tools and machines are usually very expensive, the requirements in respect of the (casting) tools, defining moulds and equipment for carrying out the present method are comparatively reasonable.

Furthermore, basically all plane and profiled flat materials, e.g. special-steel sheets and special-steel fabrics, glass-fibre-reinforced plastic, ceramics, composite materials, coated, especially nanocoated, materials, polytetrafluoroethylene (PTFE), polysulphone ether and other plastics, can be connected to one another. Even materials which cannot readily be joined per se, such as, for example, Teflon®, can be connected by the method. In a preferred embodiment, an element made of Teflon® is perforated in the edge region, for example by providing the edge region with holes. As a result, a mechanical connection is created by the casting compound reaching into the perforations.

The edge-forming and joining method is an extremely material-preserving method. No pressure points and material weakening whatsoever occur; consequently, places where the elements may break when in use cannot even arise to begin with. No shrinkage and sprues arise either, as is customary in methods for hot injection moulding of plastics. Unlike welding methods, where leak-tightness problems are common due to the localised treatment, in the method according to the invention not only do they not even occur to begin with, but they are actually solved by it. Finally, in the case of edge enclosures and connections which are formed by pressing together rings etc., a varying deformation of the edge region occurs, e.g. locally on one side. Since the edges of the element are not subjected to any pressure, no deformations of or other damage to the element can occur.

Until now, it has not been possible in the prior art to provide “flat” edge enclosures of, for example, filter means without subjecting the filter membranes to great mechanical stress. Regardless of whether, for example, welding has been employed or whether a plastic ring joined the individual layers, damage to the material always occurred, for example due to the layers being pressed together. Now, it is possible to produce an edge enclosure which apart from being extremely flat, i.e. having substantially no edge with respect to the outer filter membrane layers, does not damage the material whatsoever. An edge enclosure of flat design is understood to mean that the surfaces of the filter material, e.g. the outer surfaces of the outermost membranes, lie as far as possible in one plane with the planes of the surface of the edge enclosure, but that the planes are, however, displaced only slightly parallel to one another. Consequently, the height of the edge enclosure in cross-section corresponds substantially to the height of the filter material in cross-section.

The finished edge enclosure is, moreover, very homogeneous; no air inclusions occur. In addition, the casting compound in the edge region penetrates through the element, resulting in a good join. The edge enclosure thereby holds better than, for example, welded elements, so that in the case of filter means backwashing is possible without any problems and without the risk of the individual elements being detached from one another. However, the casting compound remains restricted to the edge region, i.e. is not conducted by capillary forces in the direction of the centre of the element. In the case of filter means, the maximum filter area is thus available.

Furthermore, porous drainage fabrics and spacers can be joined in the edge region without obstruction. By means of the edge enclosure, the element is simultaneously sealed and, when joining a plurality of elements, mutual sealing of the individual layers with respect to one another takes place. This is very important particularly in the case of filter means. Filtrate which has penetrated through the membranes must not be mixed with unfiltered suspension any more. It is therefore important to separate the individual areas in the filter means from one another. This is effected by the sealing in the edge region.

By means of a preferred exemplary embodiment of the method according to the invention, a disc-shaped element can be provided with a form-fitting, in particular sealing, edge enclosure in a single operation. The element may, furthermore, be simultaneously joined and sealed and further parts, such as nozzles, electronic components etc., may even be integrated. There is thus no need for additional working steps, as in the case of certain methods in the prior art.

In contrast to the known injection moulding method, substantially no binding defects, such as air inclusions, flowmarks or shrinkage cavities, are present in the finished edge enclosure owing to the method according to the invention. By rotation of the defining mould, the edge enclosure is built up from the outside inwards, so that the edge bond formed in accordance with the invention is always leak-tight. Owing to the spinning process, the casting compound remains homogeneous and local cooling does not occur, as it does in the injection moulding method.

With the method according to the invention, not only circular or polygonal disc-shaped elements can be provided with an edge enclosure, but also those with a different geometrical shape, in particular elements with straight sides such as triangles and rectangles. These elements can be surrounded with a form-fitting edge enclosure in a plurality of operations. One possibility for this is to form an edge enclosure one side after another with the aid of a defining mould having a greater diameter than the diameter of the element. Here, too, the casting compound is brought into the edge region of the element by rotation. On the side furthest away from the axis of rotation of the defining mould, the casting compound will concentrate and after curing form an edge enclosure there. By rotating the element so that the adjacent side which still has no edge enclosure lies in the annular channel, and renewed rotation of the mould, casting compound is concentrated on this side and an edge enclosure is formed there. Disc-shaped elements having very diverse geometrical shapes can thus be provided with a form-fitting edge enclosure using a basic method in which a defining mould which surrounds at least one side of a disc-shaped element is provided, and casting compound is hurled into the edge region of the element, whereby the casting compound concentrates there and after curing forms an edge enclosure. With this method, it is also possible to process many elements simultaneously. A further advantage lies in the fact that elements having greatly varying sizes and geometrical shapes can be processed simultaneously. An alternative method provides for standing rectangular or polygonal elements in the defining mould. By introducing casting compound and rotation, the edge enclosure is again formed. If, for example, a single rectangular element is rotated about its centre axis running parallel to the disc plane, two sides can be provided with the edge enclosure simultaneously. A plurality of elements may, however, also be arranged vertically in the defining mould about the axis of rotation of the defining mould. The edge enclosure is then formed only on one side.

As “casting compound”, it is possible to use any material with which an edge enclosure can be produced. Preferably, plastics, in particular thermoplastics or thermosets, are used. These should cure to form a solid mass. The material must be of such a nature that it can satisfy the subsequent requirements and conditions to which the finished element is subjected, for example in the case of filter means as regards the chemical and thermal resistance or the compatibility with substances to be filtered, e.g. foodstuffs. The casting compound may be constituted by organic and inorganic compounds which, in turn, set physically or else cure chemically or by the action of light, e.g. under infrared- or UV-light irradiation. Waxes or other sealing materials, as well as metals, e.g. lead, tin or aluminium, and other joining materials, could, for example, also be used as casting compound.

The casting compound is introduced into the defining mould. This may take place in liquid form or as a solid, e.g. as granules which are then liquefied. Liquid casting compound is preferably introduced, e.g. poured in, during the rotation of the element. This preferably takes place already in the region where the edge enclosure is subsequently to be formed. In principle, however, it is also possible to introduce the casting compound in the central region of the element, at a distance from the edge. The liquid casting compound may, when joining a plurality of elements, also be applied firstly to the uppermost element and only then are the elements rotated. The edge enclosure will be formed in this way, too. If the casting compound is in the form of granules upon introduction, these are preferably introduced into the defining mould before the rotation is started. The element is then rotated, whereby the granules pass into the edge region. By the action of heat, the granules melt and form the edge enclosure.

With the method according to the invention, it is also possible to produce edge enclosures in which sensors or other electronic components are cast. For this, the components as well as the disc-shaped elements are arranged in the defining mould in the way in which they are to be cast in. Now, in a single operation, the edge enclosure is formed and the components incorporated simultaneously. It is of course also possible to incorporate all other parts into the edge enclosure in this way, such as, for example, magnets, metal elements, coils, etc.

By appropriate profiling of the defining mould, the edge enclosure may be provided with profiles. It is thus possible to form, for example, fluidically favourable edge enclosures around filter means. So-called guide vanes, i.e. projections and profilings of the edge enclosure which favourably influence the flow via the filter means particularly in the case of cross-flow filtration, may be mentioned as an example of this.

It is also possible to provide a disc-shaped element in the prestressed state with the edge enclosure. For example, one or more layers of a filter means, e.g. a metal fabric, glass fibre fabric, strands, bars, struts, etc., may be prestressed. This could be effected, for example, in the manner of a tennis racket or bicycle tire tire. Steel reinforcements may be prestressed, for example, at 50-300 N/mm². If the edge enclosure is now formed, the prestress is retained and the filter means will be extremely stable. Forces which occur are transmitted into the edge enclosure. Very thin and stable filter means or other disc-shaped elements may thus be produced.

The defining mould according to the invention has an upper part and a lower part which together form the defining mould. It should be pointed out that upper part and lower part may also be designed in one piece, e.g. in the case of a flexible mould or a permanent mould. An annular channel is formed in the defining mould. The annular channel may be designed to run all the way round or in sections. The defining mould is dimensioned such that the elements around which an edge enclosure is to be formed can be introduced and that they are surrounded by the defining mould, with preferably a certain distance remaining in the edge region of the element and formed by the annular channel. The casting compound which forms the edge enclosure can then be introduced into the annular channel. A cover is preferably provided, which covers the element and holds it so that it remains in place during the rotation and does not slip, thereby ensuring the formation of a uniform, homogeneous edge enclosure.

The lower part of the defining mould is preferably of continuous design, i.e. in the manner of floor. However, to carry out the method according to the invention, it is sufficient for the defining mould to be in the shape of a ring, i.e. for lower part and upper part merely to be formed in the edge region of the element and for the central region to remain open. The defining mould may, furthermore, have one or more bores in the region of the annular channel, via which bores excess casting compound can be carried away, so that the thickness of the edge enclosure is always constant, regardless of the thickness of the elements to be enclosed and of the amount of casting compound introduced.

The defining mould may also be in the form of a permanent mould, i.e. a mould which has become an integral part of the edge enclosure after the method has been carried out. Such a defining mould could take the form of a plastic ring which is placed around the element to be enclosed. The casting compound introduced will then connect the defining mould to the element.

For the methods according to the invention, two types of deforming moulds are provided. In the case of the first type, the defining mould is designed such that it surrounds a single element or a plurality of elements lying above one another or standing behind one another. It is, for example, particularly suitable for circular elements which are laid in the mould, or for polygonal elements which are stood in the mould. In the case of the second type, which serves in particular for the production of an edge enclosure for polygonal elements, the diameter of the defining mould is greater than the diameter of the elements to be enclosed. This defining mould has an annular channel, too. A plurality of elements, which may also consist of a plurality of individual layers to be joined, can be laid in such a defining mould beside one another. The elements are in this case laid with one side in the annular channel, at a certain distance from the edge of the defining mould, in a similar manner to that in which a single element is laid in the defining mould of the first type. By means of the spinning process, an edge enclosure is in this case formed around only this side lying in the annular channel. In the case of this variant, the diameter of the defining mould is very much greater than the diameter of the element, for example 5-10 times greater. The edge enclosure will thereby admittedly have a slight curvature, i.e. be somewhat thinner in the middle region of the side than in the corner regions, but since the diameter of the defining mould is very much greater than the diameter of a single element, this curvature will be small. The diameter of the defining mould should therefore preferably be such that after the formation of the edge enclosure the thickness of the edge enclosure at the thinnest point differs by at most 50% from that at the thickest point. Consequently, in this case the edge enclosure is formed separately on each side of the element. This defining mould is particularly well-suited for the formation of an edge enclosure on elements with angular geometrical shapes, in particular triangles, rectangles and polygons with a relatively small number of vertices. In the case of a further mould, the diameter of the defining mould is likewise greater than the diameter of the largest element to be enclosed, to be precise about twice as large. The elements are in this case stood in the mould and arranged around the axis of rotation of the defining mould.

The defining mould may be produced from any suitable material, in particular but not limited to from metal or plastics, and also from flexible material such a silicone. A person skilled in the art will know which material is particularly suitable for the intended purpose.

### BRIEF DESCRIPTION OF THE DRAWINGS

The invention is explained and described in more detail below with reference to the drawings, in which:

FIG. 1 shows a defining mould according to the invention, in plan view.

FIG. 2 shows a partial section along the line II-II through the defining mould of FIG. 1 before the introduction of casting compound (A) and after the formation of the edge enclosure (B).

FIG. 3 shows a partial section through a finished, enclosed disc-shaped element.

FIG. 4 shows a partial section through a further finished, enclosed disc-shaped element.

FIG. 5 shows a plan view of a schematic illustration of a further embodiment of a defining mould according to the invention.

FIG. 6 shows a further exemplary embodiment of a defining mould in plan view.

FIG. 7 shows a partial section along the line VII-VII in FIG. 6.

FIG. 8 shows a partial section through a further finished, disc-shaped element, produced using the defining mould of FIGS. 6 and 7.

### DETAILED DESCRIPTION OF THE PREFERRED EMBODIMENTS

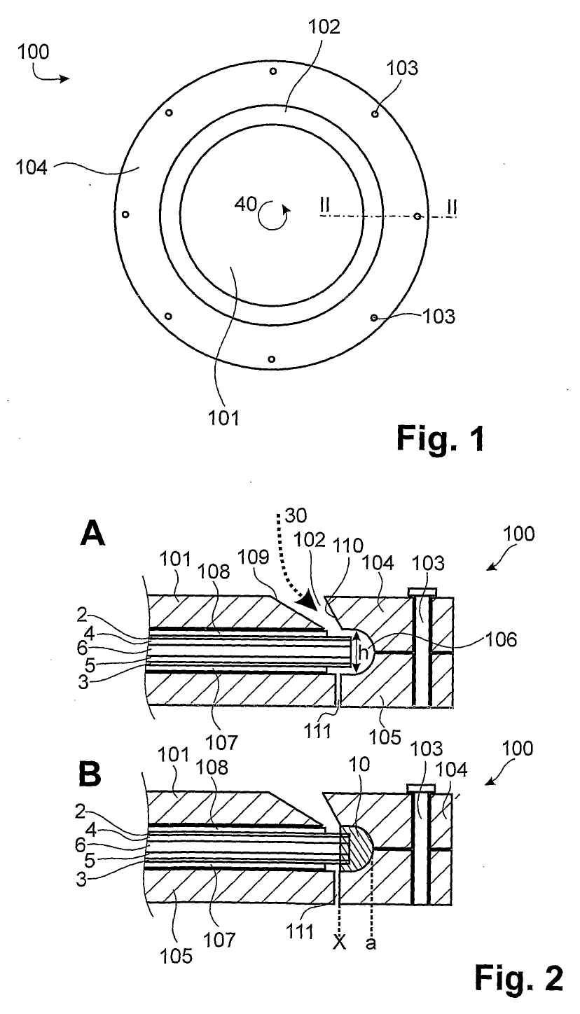

The method according to a preferred embodiment of the invention, and also the structure of a defining mould according to the invention, become clear when FIGS. 1-4 are viewed together. By way of example, the production of a disc-shaped element in the form of a filter means 1 is presented.

The defining mould 100 comprises an upper part 104 and a lower part 105. These parts are connected to one another via bolts 103 to form the defining mould 100. Also provided is a cover 101, which is placed in a centred manner upon the laid-in elements 2, 3, 4, 5 and 6. If necessary, the cover 101 may be fixed to the upper part 104 and/or the lower part 105. In principle, the cover 101 may also be dispensed with. It has proved advantageous, however, to provide a cover, since a certain contact pressure is thereby provided, by which the laid-in elements 2-6 are brought close together and are held together, so that they remain exactly on top of one another even during the rotating operation. In the case of a flexible or a permanent defining mould, upper part 104 and lower part 105 may, in principle, also be designed in one piece. They form an annular channel 106, which reproduces and defines the shape and the dimensions of the subsequent edge enclosure 10. To introduce casting compound there is provided a feeding-in channel 102, which in the exemplary embodiment of FIGS. 1-4 is designed to run all the way round. The feeding-in channel 102 may also be dispensed with or one or more bores may be provided, via which the casting compound is introduced. For protection of the elements 2-6, rubber plates 107 and 108 may be provided between the defining mould 100 and the elements 2-6. Instead of a plate made of rubber, one made of any other suitable material may be used, e.g. silicone or felt. As will be explained below, it may also be advantageous to dispense with the rubber plates 107 and 108.

For the edge enclosure and joining of a disc-shaped element, for example a filter means 1a (FIG. 3), the elements 2a-6a required therefor are laid in the defining mould 100 on top of one another, and on the rubber plate 107. After the upper rubber plate 108 has been put on, the cover 101 is likewise put on. The state illustrated in FIG. 2A is reached. The defining mould 100 is now rotated, as indicated by the arrow 40 in FIG. 1. Both anticlockwise and clockwise rotation are, of course, possible. While the defining mould 100 and thus the elements 2a-6a are rotating, liquid casting compound is introduced via the feeding-in channel 102, as indicated by the arrow 30 in FIG. 2A. From FIG. 2B, it becomes clear that the casting compound accumulates in the annular channel 106 due to the rotation. The casting compound is hurled into the annular channel 106 and localised there. After the curing of the casting compound, the edge enclosure 10 has formed around the edge region 7 of the elements 2a-6a. The filter means 1a can now be removed from the defining mould 100.

The feeding-in channel 102 is formed by the edge 109 of the cover 101 and the edge 110 of the upper part 104, as is evident from FIG. 2. Preferably, at least the edge 109 is bevelled. As it is being poured into the defining mould 100, the casting compound glances off this bevel and experiences advantageous guidance—in addition to the centrifugal force caused by the rotation—in the direction of the annular channel 106. Preferably, the edge 110 is also somewhat bevelled. As a result, sharp corners and edges are avoided, the casting compound is guided and places where soiling can occur are reduced. By means of this design of the defining mould 100, the latter has been shown to have relatively little susceptibility to soiling. Since the casting compound is optimally guided into the annular channel 106 by the bevels of the edges 109 and 110 in combination with the centrifugal force caused by the rotation, it does not come into contact with other regions of the elements 2-6. The centrifugal force acting substantially prevents casting compound from adhering on the elements 2-6 and on other parts of the defining mould 100. It is concentrated at the place where the edge enclosure 10 is to form, namely in the edge region 7 of the filter material 1a.

From the section of FIG. 2, it becomes clear that the amount of casting compound and the shape of the annular channel 106 determine the thickness of the edge enclosure 10. The annular channel 106 defines, due to its shape, the shape of the subsequent edge enclosure 10. The height H of the edge enclosure 10a is determined by the height h of the annular channel 106. The height h is in this case at least as great as the height D of the individual element which is to be enclosed or of the elements 2-6 on top of one another which are to be enclosed. In the exemplary embodiment of FIGS. 1-3, preferably h>D. The depth T of the edge enclosure 10a is determined by the amount of casting compound for the given annular channel 106. T corresponds to the distance of the edge X of the edge enclosure 10 from the vertex a of the annular channel 106. If the amount of casting compound is less than in the example presented, then the edge X is formed further in the direction of the vertex a; T decreases. If more casting compound is introduced, the edge X shifts in the direction of the centre of the filter means 1a; T increases. It is easy for a person skilled in the art to adjust the optimal amount of casting compound such that a sufficiently thick edge enclosure and, in the case of joining, a good bond of the elements 2-6, is achieved, while at the same time preserving as large a filter area as possible, for example. The adjustment of the amount of casting compound is facilitated in the exemplary embodiment of FIG. 2 by a bore 111. The bore 111 is provided in the lower part 105 of the defining mould 100; however, it could also be provided in the upper part. It serves to carry away casting compound. If the amount of casting compound introduced reaches the bore 111, excess casting compound will flow away downwards through the bore 111. It is thus simple always to form an edge enclosure 10 of the same thickness.

The filter means 1a produced in the exemplary embodiments of FIGS. 1-2 and illustrated removed from the mould in FIG. 3 comprises five elements, denoted by 2a-6a in FIG. 3. The middle element 6a is a spacer fabric, also called a spacer. It supplies the filtrate to a filtrate discharge line on subsequent use of the filter means 1a. Furthermore, it keeps the actual filter membranes apart. The spacer fabric is surrounded by respective elements 5a and 4a, which in this case are constituted by a coarse drainage fabric. Finally, the filter means is terminated outwardly by the elements 2a and 3a, the actual filter membranes. Their pore size determines the filtration capacity. In the exemplary embodiment of FIGS. 1-3, the elements 2a-6a have at least approximately the same diameter. Their edges each lie on top of one another (cf. reference symbol 7).

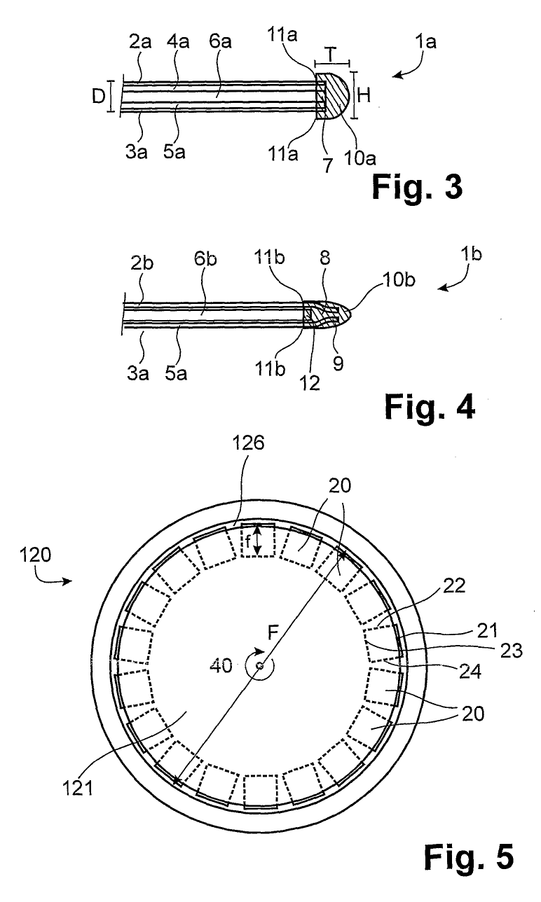

In an alternative embodiment, illustrated in FIG. 4, the diameters of the individual elements may, however, also be different. The filter means 1b comprises three elements 2b, 3b and 6b. The middle element 6b has a smaller diameter than the elements 2b and 3b surrounding it. Their edge regions 8 and 9 project beyond the edge region 12 of the element 6b. These edge regions 8, 9 may then be brought together, as is evident from FIG. 4. It is thereby possible to form a relatively flat edge enclosure 10b, without a step or with only a small step 11b. The step 11a of the edge enclosure 10a, by contrast, is relatively large (cf. FIG. 3). This alternative embodiment is particularly well-suited for providing a very flat filter means 1b. It should, however, be pointed out that a very flat edge enclosure can also be produced with the disc-shaped element(s) of the same diameter (as in FIGS. 1-3). If the rubber plates 107, 108 are omitted, then the elements 2-6 lie directly against the lower part 105 and the cover 101. As a result, a step 11a is not formed.

FIG. 5 schematically illustrates an alternative defining mould 120. In principle, it is of a similar structure to the defining mould 100. The diameter F, measured from the vertex of the annular channel 126, is, however, very much greater than the diameter f of the disc-shaped elements 20. As is evident from the illustration, a plurality of disc-shaped elements 20 are laid in the defining mould 120 beside one another. In doing so, the side 21 of each disc-shaped element 20 is inserted into the annular channel 126, at a certain distance from its vertex. Due to the rotation 40, casting compound is hurled into the annular channel 126 and an edge enclosure is formed on the side 21. By now introducing the side 22 into the annular channel, an edge enclosure is formed there. The same procedure is used for the sides 23 and 24 until all the sides 21-24 are provided with an edge enclosure, so that the edge enclosure running all the way round has been formed. The defining mould 120 may likewise have a cover 121, which is placed upon the elements 20. A feeding-in channel is again formed between cover 121 and the upper part of the defining mould 120.

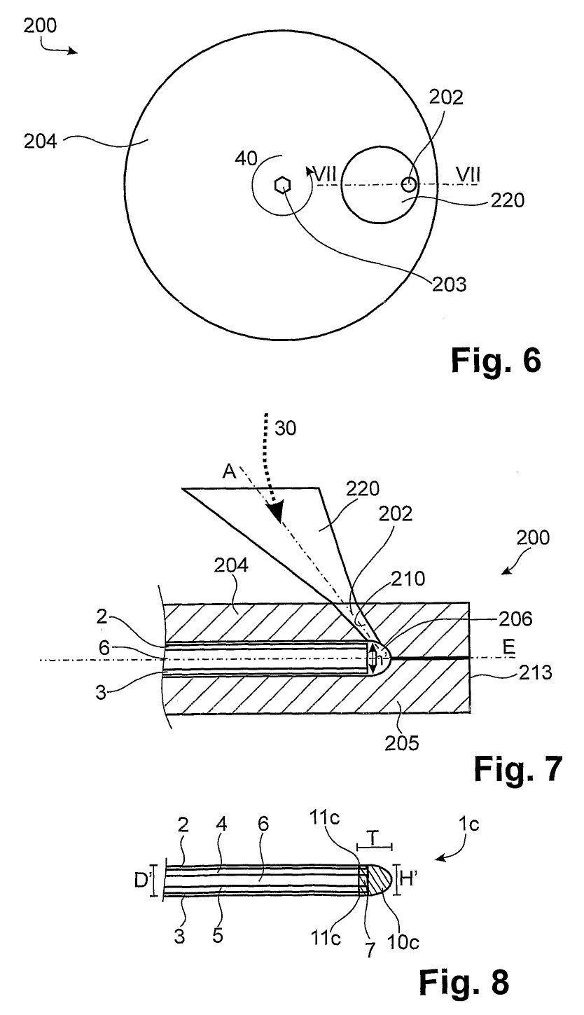

FIGS. 6 and 7 show a further exemplary embodiment of a defining mould 200. The latter is in two parts, in contrast to the defining mould 100. It comprises an upper part 204 and a lower part 205. These parts are connected to one another via a centrally arranged bolt 203 to form the defining mould 200. The central arrangement of a single bolt 203, in contrast to a plurality of bolts in the edge region (cf. reference symbol 103 in FIG. 1), affords the advantage that the defining mould can be quickly closed, meaning a saving of time in the production of elements provided with an edge enclosure. In addition, the centrally provided bolt 203 is advantageous where the enclosure of discs of filter means is concerned, since these discs have an opening centrally for subsequent mounting in a filter device. Upper part 204 and lower part 205 form an annular channel 206, which reproduces and defines the shape and the dimensions of the subsequent edge enclosure 10c. To introduce casting compound, a feeding-in channel 202 is provided. The feeding-in channel 202 in the embodiment of FIGS. 6 and 7 is a bore. This bore may be specially designed, as illustrated in FIG. 7. Preferably, the feeding-in channel 202 is designed in an obliquely running manner, i.e. its axis A, marked in FIG. 7 by a dot-dash line, is at an angle to the plane E, likewise marked in FIG. 7 by a dot-dash line, of the receiving space which is formed by upper and lower part 204, 205 and in which the elements 2, 3 and 6 are laid, which angle deviates from the perpendicular, in particular at an angle of 25-75°. As a result of the oblique shape, the casting compound is supplied to the annular channel 206 upon rotation of the defining mould 200 (arrow 40). It is particularly important for the surface 210 of the feeding-in channel 202 closest to the outer edge 213 to be obliquely designed (cf. also FIG. 2). The feeding-in channel 202 may have any shape favouring the introduction of the casting compound. In the embodiment of FIGS. 6 and 7, the feeding-in channel 202 is formed as a bore in the defining mould 200 itself. To introduce the casting compound during the rotation of the defining mould 200, a funnel 220 may be put on, for example screwed on by means of a thread. This funnel 220 is preferably dimensioned such that the casting compound required for the formation of the edge bond can be introduced all at once by a single filling of the funnel 220. Instead of a funnel 220, a cartridge which is put on the feeding-in channel 202 may also be provided. Furthermore, it is also provided that, where a 2-component material is used as casting compound, two funnels 220 or cartridges may be put on simultaneously and the mixing of the two components takes place during the spinning of the defining mould. It is advantageous that premature curing is prevented and the user does not need to perform the mixing manually. Making-up is also facilitated, in particular by using cartridges. In the embodiment of FIGS. 6 and 7, it is important that merely one, or optionally more, bore(s) open into the annular channel, in contrast to the embodiment of FIGS. 1 and 2. Instead of putting on a funnel, a channel running all the way round may therefore also be formed in the upper part 204 of the defining mould 200, similarly to the feeding-in opening 102 of FIG. 1, in which case, however, only a single bore or optionally a few bores then actually open into the annular channel. The feeding-in channel 202 is formed in the region of the annular channel 206. The casting compound thus passes into the region around the elements 2, 3 and 6 where the edge enclosure 10c is to be formed.

For the edge enclosure and joining of a disc-shaped element, for example a filter means 1c (FIG. 8), the elements required therefor, in the embodiment of FIGS. 6 and 7 the elements 2, 3 and 6, are laid in the defining mould 200 on top of one another. After closure of the mould by the bolt 203, the defining mould 200 is rotated. While the defining mould 200 and thus the elements 2, 3 and 6 are rotating, casting compound is introduced via the feeding-in channel 202 and accumulates in the annular channel 206 due to the rotation. After the curing of the casting compound, the edge enclosure 10c has formed around the edge region 7 of the elements 2-6. The filter means 1c can now be removed from the defining mould 200.

From the sectional illustrations of FIGS. 7 and 8, it becomes clear that the amount of casting compound and the shape of the annular channel 206 determine the thickness of the edge enclosure 10c. The height H′ of the edge enclosure 10c is determined by the height h′ of the annular channel 206. The height h′ corresponds in this case substantially to the height D′ of the individual element which is to be enclosed or of the elements 2, 3 and 6 on top of one another which are to be enclosed. In the exemplary embodiment of FIGS. 6-8, preferably h=D. As is evident from FIG. 8, the edge enclosure is very flat, i.e. there is substantially no step 11c between the surface of the enclosed filter means 1c and the edge enclosure 10c. Consequently, the edge enclosure 10c does not project beyond the surface of the enclosed element. This reduces the overall height and shadow formation during the operation of the filter means is avoided. The depth T of the edge enclosure 10c is determined by the amount of casting compound for the given annular channel 206, as explained above in relation to FIGS. 1-3.

The method according to the preferred embodiment of the invention and the defining mould according to the invention are suitable for the edge enclosure of all kinds of disc-shaped elements. In the exemplary embodiments, the production of filter means has been explained as one possible field of application. Equally, however, any other disc-shaped elements may be joined and provided with an edge enclosure. An example which may be mentioned is the joining and sealing of fuel cells. An edge enclosure may also be formed, for example, around an individual screen. Furthermore, multi-stage screens and multi-stage filters, for example, may also be produced. In this case, a plurality of screens or filters are laid in a defining mould above one another and at a certain distance from one another. Due to the spinning, casting compound will form an edge enclosure in the form of a wall. Nozzles and/or supply and discharge lines may be introduced into the wall before the formation of the edge enclosure and are then cast in directly during the formation of the edge enclosure.

The basic principle of the method according to the invention is likewise suitable for the production of an edge enclosure alone, e.g. for use as a seal. For this purpose, the defining mould is provided as described above. The annular channel may in this case have features, so that a profile or other structures required for the seal are formed. In this case, however, a disc-shaped element is not laid in, but merely casting compound is introduced into the defining mould, as described above. Due to spinning, the compound is concentrated in the annular channel and can cure there. Seals can thus be produced by a simple method.

1. A method for forming an edge enclosure around an edge region of an at least one flat disc-shaped element, comprising the steps of:
arranging the at least one flat disc-shaped element in characterised in that a defining mould which surrounds the element at least at the edge region;
rotating element;
introducing casting compound into the defining mould, the casting compound localizing and curing in the edge region so as to produce the edge enclosure which surrounds the element in a substantially form-fitting manner on all sides thereof, the product being flat and disc-shaped.

2. The method according to claim 1, wherein the arranging step comprises the step of arranging at least two elements one on top of the other in the defining mould, wherein the edge enclosure produced joins the elements.

3. The method according to claim 1, wherein the introducing step occurs during the rotating step.

4. The method according to of claim 1, wherein the casting compound is liquid upon introduction.

5. The method according to claim 1, wherein the casting compound is introduced during the introducing step as granules and during the rotation step heat acts thereon, so that the granules melt and the edge enclosure is formed.

6. The method according to claim 2, wherein the at least two elements are filter membranes and/or spacer fabrics, further comprising the step of joining the at least two elements together to form a filter means.

7. The method according to claim 1, further comprising the step of prestressing the element before the formation of the edge enclosure so that the edge enclosure is formed in the prestressed state.

8. The method according to claim 1, further comprising the step, after the arranging step, of inserting electronic components or other parts into the edge enclosure.

9. The method according to claim 1, wherein the element is laid in or stood in the defining mould.

10. A method for forming an edge enclosure around a plurality of rectangular elements, comprising the following steps:
a. Providing a defining mould, whose diameter is very much greater than the diameter of the elements;
b. Arranging the elements beside one another, in the defining mould, the arrangement being such that one side of each of the elements is situated in an annular channel of the defining mould, so that the defining mould surrounds the side;
c. Rotating the elements by rotation of the defining mould, whereby casting compound introduced into the defining mould localises in the region of that side of each element which is situated in the annular channel;
d. Curing of the casting compound, so that an edge enclosure is produced there, which surrounds the on the side in a form-fitting manner;
e. Rotating the at least one elements, so that it is arranged with the next side in the annular channel in accordance with step b;
f. Repeating steps c to e until each of the elements is completely surrounded by the edge enclosure.

11. A defining mould for receipt therein of at least one disc-shaped element, comprising an upper part and a lower part connectable to one another, wherein the upper part and lower part form an annular channel into which casting compound is introducible, the annular channel shaped in such a way that an edge enclosure is formable around the at least one element.

12. The defining mould according to claim 11, characterised in comprising a cover placeable over the at least one element and a feeding-in channel being formed between an edge of the cover and an edge of the upper part, via which feeding-in channel the casting compound is introducible.

13. The defining mould according to claim 12, wherein the edge of the cover is bevelled and/or the edge of the upper part is bevelled.

14. The defining mould according claim 11, characterised in wherein at least one bore is formed in the region of the annular channel, via which excess casting compound is dischargeable.

15. The defining mould according to claim 11, further comprising a feeding-in channel forming at least one bore in the upper part.

16. The defining mould according to claim 12, wherein the feeding-in channel runs at an angle to a plane of the defining mould, which angle deviates from the perpendicular to this plane, in particular at an angle of 25-75°.

17. The defining mould according to claim 15, wherein a surface of the feeding-in channel is situated in the direction of an outer edge of the defining mould and is obliquely designed to be precise such that the surface is inclined in the direction of the center of the defining mould.

18. The defining mould according to claim 15, characterised in wherein the feeding-in channel is formed in the region of the annular channel.

19. The defining mould according to claim 15, wherein the feeding-in channel runs at an angle to a plane of the defining mould, which angle deviates from the perpendicular to this plane, in particular at an angle of 25-75°.

20. The defining mould according to claim 12, wherein a surface of the feeding-in channel is situated in the direction of an outer edge of the defining mould and is obliquely designed to be precise such that the surface is inclined in the direction of the center of the defining mould.

21. The defining mould according to claim 15, wherein the feeding-in channel is formed in the region of the annular channel.
